(19) United States
(12) Patent Application Publication
(10) Pub. No.: US 2007/0029952 A1
(43) Pub. Date: Feb. 8, 2007

(54) Coherent emission of spontaneous asynchronous radiation

(76) Inventor: Scott Davis, Foothill Ranch, CA (US)

Correspondence Address: SWERNOFSKY LAW GROUP PC, P.O. BOX 390013, MOUNTAIN VIEW, CA, 94039-0013, US

(21) Appl. No.: 11/198,917

(22) Filed: Aug. 4, 2005

(51) Int. Cl. H05H 7/00; H01J 23/00; H01J 23/34; H01J 25/00

(52) U.S. Cl. 315/500

(57) ABSTRACT

Particles are sorted for emitting coherent radiation, specifically high-energy particles capable of coherent emission. Particles move toward a coherent emission chamber using molecular flow, so coherently emitting particles are collimated and minimize their distribution of output frequencies. Particles exit a coherent emission chamber in molecular flow, so coherent emission emits large amounts of energy per photon. Particles for coherent emission are energized in one or more energy modes: rotational, translational, or vibrational. Particles add translational energy using an accelerator. Energized particles reach tri-energy equilibrium after a relatively small number of collisions. Energized equilibrated particles are selected responsive to those modes, providing particles with substantially known energy distribution in each mode. Sorting particles by velocity restricts selected particles to those also having high rotational and vibrational energies. Selected particles spontaneously coherently emit radiation, so they release energy from one of the energy modes, not necessarily the energy mode for selection.

### CROSS-REFERENCE TO RELATED APPLICATIONS

This application claims priority of the following applications, each hereby incorporated by reference as if fully set forth herein.
U.S. patent application Ser. No. __/____, filed this same day, in the name of the same inventor, titled “Enhanced Heteroscopic Techniques,” attorney docket number 234.1014.01, Express Mailing number EV 568 583 382 US, now pending.

### BACKGROUND OF THE INVENTION

1. Field of the Invention

The invention relates to coherent radiation emission techniques and their applications.

2. Related Art

Known lasers generally provide substantially collimated and monochromatic light, or other electromagnetic energy, by stimulated emission of photons. Stimulated emission is generally achieved by providing a population of atoms or molecules having an inverted energy distribution, also known as an “inverted population.” The atoms or molecules are increased from a base energy state Pₒ to a first energy state P₁ by energy input, sometimes known as “laser pumping.” Similarly, the atoms or molecules are increased from the first energy state P₁ to a second and higher energy state P₂ by further laser pumping. Stimulation of the atoms or molecules that are in the higher energy state P₂ causes an avalanche of photons all of near-identical frequency. When the laser is appropriately designed, the emission of these photons is also substantially collimated.

Known problems in the art include:
In laser designs involving atomic transitions, such as for example He—Ne lasers, there is often difficulty in obtaining sufficient energy output, and in obtaining sufficient energy output efficiency.
In laser designs involving molecular energies, such as for example CO₂ gas lasers and gas dye lasers, there is often difficulty in obtaining a narrow band of frequencies for the output photons.
In nearly all laser designs, there is difficulty providing high frequency photons, that is, photons with substantially higher energy than soft UV (ultraviolet).

Novel coherent radiation emission techniques, as described herein, solve these and other problems.

### SUMMARY OF THE INVENTION

The invention includes methods, systems, and compositions of matter, including techniques such as these. (1) Particles are sorted into a form suitable for emitting coherent radiation, with the effect that very high energy particles may be selected for a coherently emitting subset thereof. (2) Particles are drawn toward a coherent emission chamber using molecular flow, with the effect that coherently emitting particles are collimated and minimize their distribution of output frequencies. (3) Particles exit a coherent emission chamber in molecular flow, with the effect that coherent emission might be disposed to emit large amounts of energy per photon.

In an aspect of the invention, particles for coherent emission are energized in one or more energy modes, such as rotational, translational, or vibrational energy. For example, particles might add translational energy by passing through an accelerator. Energized particles are allowed to reach a state where the distribution of each energy mode is substantially known. For example, energized particles reach tri-energy equilibrium after a relatively small number of collisions. Energized particles are selected responsive to at least one energy mode, providing a set of particles with substantially known distribution in each energy mode. For example, sorting particles by velocity restricts selected particles to those having high rotational and vibrational energies as well. Selected particles are allowed to coherently emit radiation, with the effect of releasing energy from one of the energy modes, not necessarily the one by which the particles were selected.

In an aspect of the invention, particles for coherent emission are sorted by velocity, with the effect that selected particles are substantially collimated and have a substantially narrow energy distribution (at least for velocity). Substantially collimated moving particles provide a molecular flow effect. Outgoing particles exit without substantial friction, while additional incoming particles are drawn in to be sorted.

In an aspect of the invention, particles are substantially energized, with the effect of increasing their energy level to a desired excited state. The particles enter a kinetic equilibration chamber, where they equilibrated their energy levels in multiple distinct modes. The particles maintain their energized state due to pressure and temperature in the equilibration chamber. The equilibrated particles flow at their thermal velocity into an emission chamber, with the effect that they release energy (in the form of photons) from their vibrational modes using one or more bounces against a cryogenic surface, with the effect of causing coherent emission. Those particles which release photons retain only translational velocity, with the effect that they remain moving, but without substantial thermal energy. This has the effect that very high amounts of thermal energy might be released in a collimated and coherent output. Moreover, this has the effect that spontaneous emission occurs substantially within one mean free path difference for the entire population of particles, with the effect of generating a coherent radiation field consisting essentially of spontaneous emissions.

In an aspect of the invention, heteroscopic features cause coordination of a large number of individual particles, with the effect of coordinating the energy available from those particles. In preferred embodiments, emitted power might be proportional to, or otherwise responsive to, a number of blades in a heteroscopic turbine, and particles are isolated in their flow into substantially a single particle, using an array of heteroscopic blade gaps, with the effect of achieving a state of free molecular flow.

After reading this application, those skilled in art would recognize that these, and other uses of heteroscopic concepts, provide both novel coherent emission techniques and novel applications of those techniques. Heteroscopic concepts allows techniques and embodiments to treat each particle individually, rather than relying on aggregate properties of the particles taken together.

As described herein, these novel coherent emission concepts and techniques are an enabling technology, capable of providing both new methods and new systems not heretofore feasible. These and other uses of the novel coherent emission concepts in nonobvious ways and to achieve nonobvious goals are further described below.

### BRIEF DESCRIPTION OF THE DRAWINGS

FIG. 1 shows a drawing of a side view of a device for coherent emission of spontaneous radiation.

FIG. 2 shows a drawing of a device for coherent emission of spontaneous radiation.

FIG. 3 shows a process flow diagram of a method including operation of a device for coherent emission of spontaneous radiation.

### DETAILED DESCRIPTION OF PREFERRED EMBODIMENTS

Although preferred method steps, system elements, data structures, and the like, are described herein, those skilled in the art will recognize that these are intended to describe the invention in its broadest form, and are not intended to be limiting in any way. The invention is sufficiently broad to include other and further method steps, system elements, data structures, and the like. Those skilled in the art will recognize these as workable without undue experimentation or further invention, and as within the concept, scope, and spirit of the invention.

### DEFINITIONS

The general meaning of each of these following terms is intended to be illustrative and in no way limiting.
The phrase “heteroscopic turbine”, and the like, generally refers to devices capable of sorting substantially microscopic particles in response to their velocity, using physical elements substantially larger than the particles to be sorted.
The term “heteroscopic” and the like generally refer to devices characterized by use 11 of microscopic or nanoscopic principles to select, sort, process or otherwise affect individual particles within a working fluid to achieve a macroscopic effect. More generally, heteroscopic devices are those that have structures much smaller in size than combined effects of those structures on a fluid. Heteroscopic devices might require operation on a population of objects whose size is much smaller the desired effects.
The term “particle” and the like generally refer to any small component of or suspended in a fluid, including but not limited to molecules, atoms, sub-atomic particles, photons, charged particles, clumps of molecules, and the like.
The term “fluid” refers to any substance whose particles move past one another and that has the tendency to assume the shape of its container. Examples include, but are not limited to, a liquid, gas, plasma, electron gas, etc.
The terms “blade,” “blade surface” and the like generally refer to any edge that moves through a fluid. The blade can be a physical, electromagnetic, chemical, nuclear, or even mathematical or statistical. The blade can be passive, affecting particles by their motion through the fluid, or active, directly affecting come property of the particles in some other way.

The scope and spirit of the invention is not limited to any of these definitions, or to specific examples mentioned therein, but is intended to include the most general concepts embodied by these and other terms.

System Elements (Linear Tube)

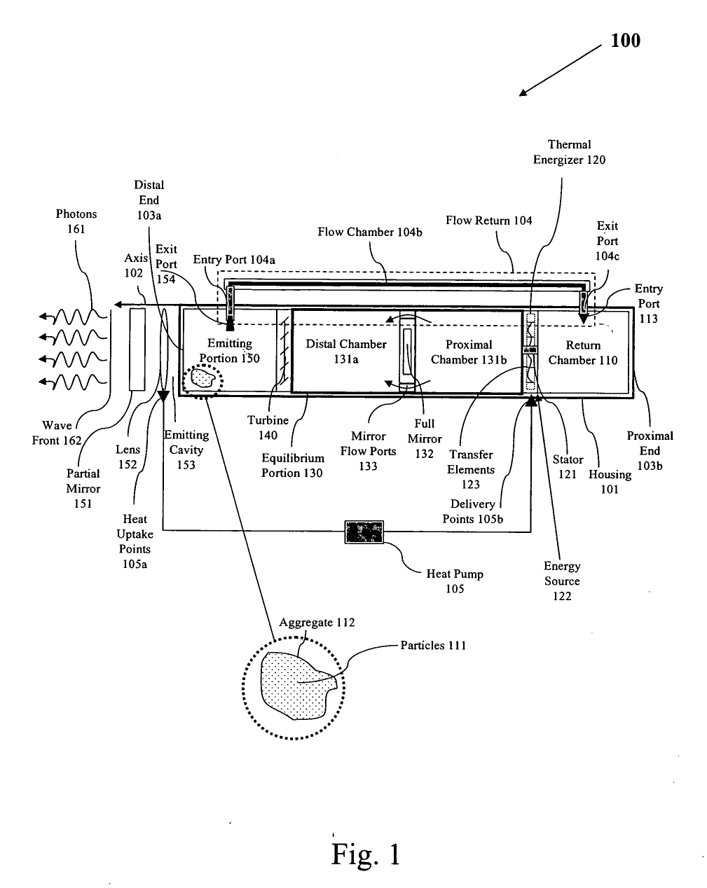

FIG. 1 shows a drawing of a side view of a device for coherent emission of spontaneous radiation.

The device 100 includes elements as shown in the figure, including at least a return chamber 110, a thermal energizer 120, an equilibrium portion 130, a turbine 140, and a emitting portion 150. The device 100 includes a housing 101, defining a shape, such as for example a cylinder having an axis 102 defined along its length, a distal end 103a (shown toward the left side of the figure), and a proximal end 103b (shown toward the right side of the figure). The device 100 also includes a flow return 104, including an entry port 104a, a flow chamber 104b, and an exit port 104c.

The device 100 also optionally includes a heat pump 105, including one or more heat uptake points 105a and one or more heat delivery points 105b. After reading this application, those skills and the art will recognize that, in the context of the invention, there is no particular requirement to use a heat pump 105, and that many other techniques for transferring heat may optionally be used.

Although the housing 101 in the figure is described as having a shape such as for example a cylinder, in the context of the invention there is no particular requirement that the housing 101 take the form of a smooth circular cylinder.

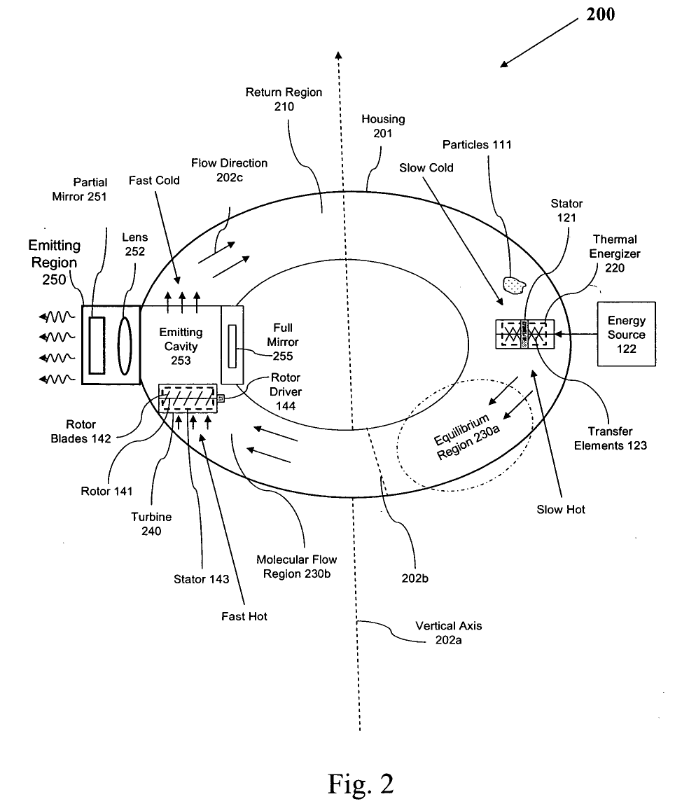

After reading this application, those skilled in the art will recognize that the housing 101 might take on any of a wide variety of shapes, including some with axial symmetry and some without axial symmetry. For one such example, the housing may have the form of a torus, as described with respect to FIG. 2.

As described below, after reading this application, those skilled in the art will recognize that the device 100 has new and special effects, described in further detail later and with regard to the figure.

Return Chamber

The return chamber 110 includes elements as shown in the figure, including at least a collection of particles 111, such as for example molecules, forming an aggregate 112, such as for example a gas.

While the particles ill in the figure are sometimes described herein as molecules, in the context in the invention, there is no particular requirement that they are so restricted. For example, in alternative embodiments, the particles 111 may include individual atoms, ions, or subatomic particles, or may include free radicals, molecular structures or substructures, or particles of substantial size, such as for example dust motes or quantum dots. For a 1^{st} example, in a microelectronic circuit, the particles might include electrons, Cooper pairs, small charge differentials, or lattice phonons. These types of particles would have uses for spectroscopic applications and for applications which use relatively low power and relatively high resolution (e.g., medical). For a 2^{nd} example, in a Bose-Einstein condensate, the particles might include the superposition of the condensate itself.

Similarly, while the aggregate 112 is sometimes described herein as a gas, in the context of the invention, there is no particular requirement that it is so restricted. For example, the aggregate 112 may include, in addition to or instead of a gas, a plasma, a fluid, or some combination or composition thereof.

The return chamber 110 receives particles 111 from an entry port 113, which is coupled to the exit port 104c of the flow return 104. As described herein, a molecular flow effect 114 causes the particles 111 to move unidirectionally from the flow return 104 into the return chamber 110. The molecular flow effect 114 also causes the particles 111 to move unidirectionally from the return chamber 110 to the thermal energizer 120.

Thermal Energizer

The thermal energizer 120 includes elements as shown in the figure, including at least a stator 121 and an energy source 122.

While the energizer 120 is described herein as using thermal energy to transfer energy to the particles 111, in the context of the invention there is no particular requirement for that one technique. In alternative embodiments, the energizer 120 may use electromagnetic or other principles, in addition to or in lieu of, thermal heating.

The energy source 122 couples thermal energy to the stator 121, with the effect of increasing the thermal energy, that is, heating, the stator 121. In those sets of embodiments when the device 100 includes the optional heat pump 105, the energy source 122 may coupled one or more of the heat delivery points 105b to the stator 121. This has the effect that the heat pump number 105 may transfer thermal energy from some other source to the stator 121.

The stator 121 includes one or more energy transfer elements 123, each of which is disposed to receive particles 111 as they pass through the thermal energizer 120, and transfer thermal energy to those particles 111. In one set of preferred embodiments, the energy transfer elements 123 include relatively microscopic (or nanoscopic) planar elements, each disposed to intersect the path of one or more particles 111, preferably not many more than one at a time. This has the effects of (1) colliding with those particles 111, (2) accelerating those particles 111 primarily parallel to the axis 102, and (3) increasing the thermal energy of, that is, heating, the aggregate 112.

While the stator 121 is described as having the particular herein, in the context of the invention there is no particular requirement for that one technique. In alternative embodiments, other devices or elements for transferring energy to the particles 111 may be used. For example, one element for transferring energy to the particles 111 may be a heated carbon charcoal filter. Particles 111 would enter that filter, bounce around awhile, and exit that filter with the added thermal energy. Particles 111 that do not exit, or which exit back to the return chamber, would cause an increase in gas pressure between the return chamber and the equilibrium chamber, forcing particles 111 to prefer moving through the filter into the equilibrium chamber.

When the aggregate 112 is heated, this has the effect that thermal energy for particles 111 in the aggregate 112 takes on a distribution in which most of the particles 111 are relatively high-energy.

Equilibrium Portion

The equilibrium portion 130 includes elements as shown in the figure, including at least a distal chamber 131a, a proximal chamber 131b, a full mirror 132, and a set of mirror flow ports 133. The distal chamber 131a is shown toward the left side of the equilibrium portion 130, while the proximal chamber 131b is shown toward the right side of the equilibrium portion 130. The full mirror 132 is shown between the distal chamber 131a and the proximal chamber 131b. The mirror flow ports 133 are shown between the distal chamber 131a and the proximal chamber 131b.

As the particles 111 enter the proximal chamber 131b, the distribution of translational energy (of the aggregate 112) is substantially high energy, while the distributions of rotational or vibrational energy (of the aggregate 112) of the particles 111 are each substantially randomly distributed. Within the proximal chamber 131b, pairs of the particles 111 collide repeatedly, relatively rapidly (within only a few collisions) equalizing the energy of each molecule 111 between its rotational, translational, and vibrational energies.

The molecular flow effect 114, as described above with regard to the return chamber 110, draws the aggregate 112 from the proximal chamber 131b to the distal chamber 131a, through the mirror flow ports 133. This has the effect that only those particles 111 reach the distal chamber 131a that have reached tri-energy equilibrium among rotational, translational, and vibrational energies.

As noted above, the translational energy imparted by the thermal energizer 120 is primarily parallel to the axis 102, substantially collimating the movement of particles 111 in the distal chamber 131a. This has the effect of generating the molecular flow effect 114 described above with regard to the return chamber 110. The molecular flow effect 114 draws particles 111 from the return chamber 110 to the thermal energizer 120 to the equilibrium portion 130. As described below with respect to a toroidal embodiment, in the context of the invention, there is no particular requirement that the particles 111 are substantially collimated upon exit from the thermal energizer 120 or even upon contact with the turbine 140.

Turbine (General Concepts)

The turbine 140, as described herein, is a generalization of the heteroscopic turbine further described in U.S. patent application Ser. No. 10/693,635, filed Oct. 24, 2003, in the name of the same inventor, titled “Heteroscopic Turbine,” attorney docket number, now allowed and pending.

As described therein, a heteroscopic turbine includes a plurality of single particle systems incorporated as a portion of or attached to a macroscopic rotor. The rotor spins with a rotor velocity comparable to the particles' velocity in an aggregate upon which the turbine operates. For example, in the case of a heteroscopic turbine that physically selects molecules from air, the enclosures might be formed by physical blades, and the rotor might be spun so that the blades move through the air at a speed comparable to the mean thermal velocity of the molecules. The edges of the blades moving through the air at this velocity result in a physical boundary defining the single particle (in this case single-molecule) enclosures. This boundary also can be viewed as a mathematical or statistical boundary defined by the different properties of the particles on both sides of the boundary.

A portion of the heteroscopic turbine interacts with a portion of a working fluid composed of or including particles. The turbine includes a plurality of single-particle systems. These single-particle systems are enclosures defined by one or more physical, mathematical, statistical boundaries, and the like. The enclosures could each contain one particle (or more than one particle in some circumstances), or be empty, or be in a transition state. The enclosures need not be regularly shaped as shown in the figure, and may have any shape.

The boundaries that form the enclosure may be viewed in different ways. Generally, any physical boundary might be defined in mathematical or statistical terms, and the like, and vice versa. It should be noted, however, that some mathematical or statistical boundaries might not appear to have a physical counterpart. Alternatively, the physical counterpart might be based on a collection of physical structures or motion, such as a plane of blade edges moving in a particular manner, and the like. The mathematical or statistical boundaries likewise might be defined, in whole or in part, in terms of space or time, or both, with respect to such physical structures and motion.

For example, side boundaries of the enclosures could be defined by physical blades, while top boundaries the enclosures could be defined by physical motion of those blades through working fluid. The top boundaries could be viewed in physical terms (a plane of motion of blade tops), in mathematical terms (based on the motion of the blades or the nature of particles captured by the enclosures), or in statistical terms (based on the statistical properties of particles on both sides of the boundary). The bottoms of the enclosures could be open or could be defined by another boundary.

In operation, the single-particle systems are attached to a spinning macroscopic rotor. The spinning rotor moves the systems through the working fluid. The spinning rotor can affect the existence or characteristics of the boundaries of the enclosures.

The velocity that the rotor moves the single-particle systems through the working fluid preferably is comparable to the velocities of the particles in that working fluid. For example, if the working fluid is air, the rotor preferably spins fast enough so that the single-particle systems move through the air at a speed comparable to a mean thermal velocity of the particles in the air.

A macroscopic rotor of a heteroscopic turbine includes single-particle systems around a periphery of the rotor. When the rotor spins, single-particle systems at the periphery of the rotor move faster through a working fluid than systems closer to an axis of rotation for the rotor. Thus, arrangement of the single-particle systems in an annulus shape is preferred, at least in some embodiments. However, in alternative embodiments, the single-particle systems may be placed all over the rotor or in any other arrangement.

In response to the design of the single-particle systems or the mode of operation of the turbine, a particle might pass through an enclosure without contacting any physical surface or might collide with a physical surface in one of the systems. In any case, physical or logical properties of those particles can be transferred, converted, maintained or eliminated, and the like, as permitted by the relevant thermodynamic, electrodynamic, or other physical laws.

Turbine (Specific Elements)

The turbine 140 includes elements as shown in the figure, including at least a rotor 141, a set of rotor blades 142, a stator 143, and a rotor driver 144.

The stator 143 maintains the rotor 141 in a position disposed relatively stably parallel to the axis 102. The rotor driver 144 spins the stator 143, with the effect of spinning the rotor 141 (or optionally spins the rotor 141 directly). The rotor blades 142 are disposed on the rotor 141 so that, when the rotor 141 is spinning, the rotor blades 142 are moving substantially in a circle whose axis is parallel to the axis 102. The rotor blades 142 are disposed at an angle to the molecular flow effect 114, that is, at an angle to the axis 102.

This has the effect that each pair of adjacent rotor blades 142 defines a moving gap, disposed at an angle to the axis 102 just as the rotor blades 142 are disposed at an angle to the axis 102. The moving gap, and its angle, has the effect that only those particles 111 having sufficient velocity to pass through the moving gap, that is, to slip between two rotor blades 142, are admitted through the turbine 140. The turbine 140 rejects particles 111 with lesser velocity, and bounces them back to the equilibrium portion 130.

This has the effect of filtering those particles 111 arriving from the equilibrium portion 130, effectively dividing them into “fast enough” and “not fast enough” particles 111. As the “fast enough” particles 111 pass through the turbine 140, pressure in the equilibrium portion 130 falls, and the molecular flow effect 114 is enhanced.

The selection of which particles 111 the turbine 141 will admit is responsive to (1) the radius of the rotor 141, (2) distance between rotor blades 142, and (3) speed of rotation, and (4) possibly other factors. The turbine 140 admits only a relatively narrow range of energies of particles 111, with the effect that all particles admitted by the turbine have only a relatively narrow range of frequencies.

Particles enter and exit the turbine 140 substantially collimated, in response to (1) the thermal energizer 120, (2) the equilibrium portion 130, (3) the turbine 140, and (4) combinations of those factors. This has the effect that the aggregate 112 exits the turbine 140 with its particles 111 disposed in substantial lock-step, aligned both axially and cross-axially, as if it comprised a sequence of parallel disks of particles 111, each of which comprised a slice of multiple parallel strings of particles 111.

Emitting Portion

The emitting portion 150 includes elements as shown in the figure, including at least a partial mirror 151, a lens 152, an emitting cavity 153, and an exit port 154, the latter coupled to the entry port 104a of the flow return 104.

The partial mirror 151, the lens 152, and the emitting cavity 153 provide the device 100 with a capacity for coherent radiation emission using the high-energy particles 111 present in the lasing cavity 153.

The high-energy particles 111 arrive in the emitting cavity 153 with a molecular flow effect 114, in lock-step, substantially collimated and with substantially identical translational velocity for each particle 111. As those high-energy particles 111 enter the emitting cavity 153, they spontaneously emit photons, with the effect of transforming them into low energy particles 111. The device 100 emits the photons axially, in the direction of the lens 152 and the partial mirror 151, as shown in the figure.

The high-energy particles 111 exited the turbine 140 with nearly identical translational energy. Those same particles 111 exited the equilibrium portion 130 with translational energy that was identical to both rotational and vibrational energies. This has the effect that those same particles 111 arrive in the emitting cavity 153 with nearly identical rotational and vibrational energies across their entire aggregate 112. Those particles 111 spontaneously emit photons with nearly identical energy in the emitting cavity 153.

The low energy particles 111 move from the emitting cavity 153 to the exit port 154, coupled to the entry port 104a of the flow return 104. The flow return 104 delivers these low energy particles 111 to the return chamber 110, as described above with reference to the flow return 104 and its exit port 104b.

The low energy particles 111 exit the emitting cavity 153 as they arrived, in similar lock-step but with greatly reduced rotational and vibrational energies. They retain only translational energy, and exit the emitting cavity 153 with the molecular flow effect 114, but without substantial thermal energy, that is, at nearly absolute zero (about 6° Kelvin).

This has the effect that particles 111 enter the emitting cavity 153 with substantially large thermal energy, such as for example in excess of 10,000° Kelvin, each emit a photon due to coherent and spontaneous emission of radiation, and exit the emitting cavity 153 with substantially no thermal energy. The particles 111 convert their “thermal” (not collimated particles 111) energy to coherent and spontaneous radiation energy (that is, collimated photons).

In one set of preferred embodiments, the rotor 141 and rotor blades 142 are transparent to the output frequency of the lasing cavity 153. However, in the context of the invention, there is no particular requirement to this effect.

The output rate of photons, that is, the time between emission events in the emitting cavity 153 is proportional to the output frequency of photons exiting the emitting cavity 153, which is itself a proportional to the energy drop of the particles 111 between their excited state exiting the thermal energizer 120 and their non-excited state after an emitting event. This has the effect that there is a correlation between the output photons' energy wavelength and the structures of the device 100.

This has the effect that the translational velocity of particles 111, between excitation and emission, is tunable responsive to the structures of the device 100. The structures include at least (a) an amount of energy applied by the thermal energizer 120, and (b) a set of speeds selected by the turbine 140. The latter is responsive to the width of the rotor 141 and a speed of rotation provided by the rotor driver 144.

As described in the Incorporated Disclosure, the turbine 140 might include a plurality of rotors 141, such as might be arranged in a set of concentric elements about a single stator 143. In embodiments including such turbines 140, the molecular flow effect 114 and the emission events in the emitting cavity 153 would each substantially provide a distinct annulus having a distinct set of output photons, each set of which would be distinguishable from the others by their distinct energies and frequencies.

Novel Results

After reading this application, those skilled in the art will recognize, as noted above, that the device 100 has new and special effects, including at least these:
The device 100 generates a set of exit photons 161, which are not only the same frequency and spatially collimated, but also issue in lockstep from time to time. This provides an output wavefront 162 for which the exit photons 161 have substantially aligned peaks and troughs as they exit the device 100.
The output rate of those output wavefronts 162 is proportional to the frequency of the exit photons 161, and therefore proportional to the width of an optical cavity for the device 100.
The device 100 generates its exit photons 161 with an energy proportional to both (1) the thermal energy drop between the thermal energizer 140 and the output temperature at the entry port 104a of the flow return 104, and (2) the average density of gas 163 being pumped through the device 100.
The thermal energy drop can be engineered to be very large, such as for example in excess of 10,000° Kelvin, responsive to a heat energy capacity of the thermal energizer 140. The average density of gas 163 can be engineered to be very high, such as for example even including the density of some fluids, responsive to a rotational speed of the turbine 120.
Novel techniques introduced by this application might be used in combination or conjunction with known laser techniques, and with other known techniques for providing emitted energy.
   System Elements (Toroidal Tube)

FIG. 2 (collectively including FIGS. 2A and 2B) show a drawing of a device for coherent emission of spontaneous radiation. FIG. 2A shows a top view. FIG. 2B shows a side view.

In one set of embodiments, a device 200 has a housing 201 in the shape of a torus. The housing 201 has a vertical axis 202a defining a plane in which the torus lies, a width 202b defining a size of the tube defined by the torus, and a flow direction 202c defining a manner in which an aggregate of particles moves within the torus, as described below.

In such embodiments, the device 200 includes elements as shown in the figure, including at least a return region 210, a thermal energizer 220, an equilibrium region 230a, a molecular flow region 230b, a turbine 240, and an emitting region 250.

In such embodiments, the device 200 need not include a flow return.

In such embodiments, the device 200 also optionally includes a heat pump 205, including one or more heat uptake points 105a and one or more heat delivery points 105b, similar to the heat pump 105.

Return Region

In such embodiments, the return region 210 is similar to the return chamber 110.

The return region 210 receives particles 111 as they exit from the emitting region 250 in the flow direction 202c, and allows those particles 111 to enter the thermal energizer 120.

Thermal Energizer

In such embodiments, the thermal energizer 220 is similar to the thermal energizer 120.

The thermal energizer 220 receives particles 111 as they exit from the return region 210 and provides thermal energy for those particles 111, with the effect that those particles 111 in the aggregate 112 takes on a distribution in which most of the particles 111 are relatively high-energy.

Equilibrium Region

In such embodiments, the equilibrium region 230a is similar to the proximal chamber 131b.

The equilibrium region 230a receives particles 111 as they exit from the thermal energizer 220 in the flow direction 202c, and allows those particles 111 to enter the molecular flow region 230b.

Similar to the proximal chamber 131b, the particles 111 enter the equilibrium region 230a with relatively high translational energy, but with substantially randomly distributed rotational and vibrational energy. Within the equilibrium region 230a, pairs of the particles 111 collide repeatedly, relatively rapidly (within only a few collisions) equalizing the energy of each molecule 111 between its rotational, translational, and vibrational energies. This has the effect that the particles 111 exit the equilibrium region 230a in tri-energy equilibrium.

After reading this application, those skilled in the art will recognize that there is no particular requirement that the equilibrium region 230a is physically separate from the molecular flow region 230b. The particles 111 are not necessarily collimated upon entry into, or exit from, equilibrium region 230a.

Molecular Flow Region

In such embodiments, the molecular flow region 230b is similar to the distal chamber 131a.

The molecular flow region 230b receives particles 111 as they exit the equilibrium region 230a in the flow direction 202c, and allows those particles 111 to enter the turbine 140.

The molecular flow effect 114, as described above, causes particles 111 to exit the equilibrium region 230a, and to enter the molecular flow region 230b in substantially collimated format.

Turbine

In such embodiments, the turbine 240 is similar to the turbine 140.

Similar to the turbine 140, this has the effect that the aggregate 112 exits the turbine 240 with its particles 111 disposed in substantial lock-step, aligned both axially and cross-axially (with respect to the axis of the turbine 240). The sequence of parallel disks of particles 111, each of which comprised a slice of multiple parallel strings of particles 111, remains locally true.

Emitting Region

In such embodiments, the emitting region 250 is similar to the emitting portion 150.

The emitting region 250 includes elements as shown in the figure, including at least an (optional) partial mirror 251, a lens 252, an emitting cavity 253, and a full mirror 255.

The emitting region 250 receives particles 111 as they exit the turbine 140 in the flow direction 202c, and allows those particles to enter the return region 210, also in the flow direction 202c.
The turbine 140 is not disposed in the emitting region 250, with the effect that it need not be transparent to the emission frequency.
Similar to the emitting portion 150, the partial mirror 151 is optional.
The full mirror 255 is not disposed within the flow direction 202c, with the effect that the full mirror 255 need not be disposed to allow particles 111 to pass through or around it.

The partial mirror 251, the lens 252, the emitting cavity 253, and the full mirror 255 provide the device 200 with a capacity for coherent and spontaneous emission of radiation, using the high-energy particles 111 present in the emitting cavity 253.

Similar to the emitting portion 150, the high-energy particles 111 arrive in the emitting cavity 253 with a molecular flow effect 114, in lock-step, substantially collimated and with substantially identical translational velocity for each particle 111. As those high-energy particles 111 enter the emitting cavity 253, they spontaneously emit photons, with the effect of transforming them into low energy particles 111.

The device 200 emits the photons radially, in the direction of the lens 252 and the partial mirror 251, as shown in the figure.

Similar to the device 100, the high-energy particles 111 exited the turbine 240 with nearly identical translational energy. Those same particles 111 exited the equilibrium region 230 with translational energy that was identical to both rotational and vibrational energies. This has the effect that those same particles 111 arrive in the lasing cavity 253 with nearly identical rotational and vibrational energies across their entire aggregate 112. When spontaneously emitting photons in the emitting cavity 253, those particles 111 emit photons with nearly identical energy.

The low energy particles 111 move from the emitting cavity 153 to the return region 210.

Similar to the emitting portion 150, the low energy particles 111 exit the emitting cavity 253 as they arrived, in similar lock-step but with greatly reduced rotational and vibrational energies. They retain only translational energy, and exit the emitting cavity 253 with the molecular flow effect 114, but without substantial thermal energy, that is, at nearly absolute zero (about 6° Kelvin).

This has the effect that particles 111 enter the emitting cavity 153 with substantially large thermal energy, such as for example in excess of 10,000° Kelvin, each emit a photon due to coherent and spontaneous emission of radiation, and exit the emitting cavity 153 with substantially no thermal energy. The particles 111 convert their “thermal” (not collimated particles 111) energy to coherent and spontaneous radiation energy (that is, collimated photons).

The emitting region 250 is tunable similarly to the lasing portion 150.

Method of Operation

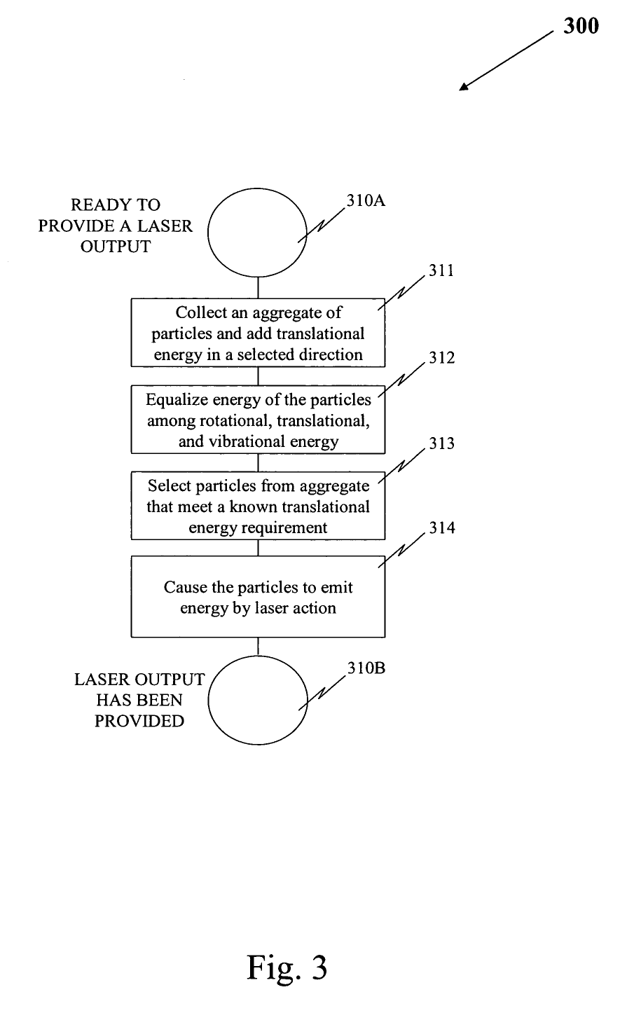

FIG. 3 shows a process flow diagram of a method including operation of a device for coherent emission of spontaneous radiation.

A method 300 includes a set of flow points and steps. Although described serially, these flow points and steps of the method 300 can be performed by separate elements in conjunction or in parallel, whether asynchronously or synchronously, in a pipelined manner, or otherwise. There is no particular requirement that the flow points or steps are performed in the same order as described, except where explicitly so indicated. Those skilled in the art will understand that the number and types of entities that can exist in the supply chain and that are used in the figures are illustrative and not intended to be limiting.

The method 300 includes flow points and process steps as shown in the figure, plus possibly other flow points and process steps as described in the incorporated disclosure. These flow points and process steps include at least the following.
A pair of flow points 310A and 310B, and a set of steps performed in between, in which the method 300 provides an output of coherent and spontaneous radiation.

At a flow point 310A, the method 300 is ready to provide an output of coherent and spontaneous radiation.

At a step 311, the method 300 collects an aggregate of particles and adds translational energy in a selected direction. In one set of embodiments, the method 300 might add translational energy using a thermal energizer, as described above. As described above, this has the effect that the thermal energy for those particles takes on a distribution in which most of the particles are relatively high-energy.

At a step 312, the method 300 equalizes the energy of the particles among rotational, translational, and vibrational energy, with the effect that the particles reach tri-energy equilibrium among rotational, translational, and vibrational energies. In one set of embodiments, the method 300 might achieve tri-energy equilibrium by allowing the particles to collide with each other, as described above.

At a step 313, the method 300 selects particles from the aggregate that meet a known translational energy requirement. In one set of embodiments, the known translational energy requirement is that of exceeding a selected velocity across a heteroscopic turbine, as described above. However, in alternative embodiments, any technique by which the method 300 might distinguish faster particles from slower particles, such as for example a centrifuge or an electromagnetic field, would allow the method 300 to select only the desired particles.

At a step 314, the method 300 causes the selected particles to emit energy by laser action. As described above, the selected particles are in tri-energy equilibrium and have a known translational requirement. This has the effect that the aggregate of particles has relatively narrow distributions of rotational and vibrational energy. This has the effect that stimulation of laser action is relatively easy, and that emitted photons all have nearly the same energy.

After reading this application, those skilled in art would recognize that the method 300 provides an output of coherent and spontaneous radiation with output photons that (1) have relatively identical frequencies, (2) are substantially spatially collimated, and (3) issue in lock-step at defined time intervals.

At a flow point 310B, the method 300 has provided an output of coherent and spontaneous radiation. In one set of embodiments, the method 300 operates continuously in parallel at each step described, with the effect of providing a coherent radiation output as long as energy is provided to the device.

Enabling Technology

After reading this application, those skilled in the art will recognize that the device 100, and the principles associated with its inventive properties, provide a new enabling technology. Using this new enabling technology, a wide variety of new devices may be constructed that previously were infeasible. Some examples include the following:
In one set of embodiments, relatively increased accuracy of the coherent radiation and its frequency spectrum might be advantageously used to coordinate multiple energy emissions to superpose that energy at a targeted location. In known systems sometimes called a “gamma knife,” there is a problem obtaining adequate focus, due in part to inability to focus a narrow frequency range and inability to superpose frequency peaks. In one set of embodiments, the relatively narrow frequency range provides a system in which multiple coherent energy emitters can be focused and superposed on a single location, with the effect of providing the ability of performing surgery within enclosed spaces, such as the human brain.
In one set of embodiments, the relatively increased accuracy of the coherent radiation and its frequency spectrum might be advantageously used to provide tomography with resolution of relatively small elements.
In one set of embodiments, the ability of focusing energy at specified locations within enclosed spaces provides the ability to deliver relatively large amounts of energy to specific locations in a closed 3D region. For a 1^{st} example, such embodiments might be used for heating, as in melting or welding metal, with the effect of repairing materials defects. For a 2^{nd} example, such embodiments might be used for etching of 3D circuitry within a silicon or other material substrate.
In one set of embodiments, relatively increased accuracy of the coherent radiation and its frequency spectrum might be advantageously used to give greater effect to a diffraction grating at the output of the emitted coherent radiation. Such a diffraction grating would be substantially less energy-inefficient in response to the relatively tight frequency spectrum. In such embodiments, and in response to one or more of gas density, rotational speed of the heteroscopic turbine, or energy drop from the thermal energizer, the frequency spectrum of the emitted coherent radiation might be altered, with the effect of altering the direction of the emitted coherent radiation substantially without any moving parts.

### Alternative Embodiments

Although preferred embodiments are disclosed herein, many variations are possible which remain within the concept, scope, and spirit of the invention. These variations would become clear to those skilled in the art after perusal of this application.
The invention is widely applicable to laser technologies of all kinds.
The invention is widely applicable to all technologies involving: (1) delivery of energy at precise frequencies, locations, or times, (2) delivery of energy in concentrated form, (3) delivery of energy without thermal waste, and the like.

After reading this application, those skilled in the art will recognize that these alternative embodiments are illustrative and in no way limiting.

### TECHNICAL APPENDIX

A Technical Appendix is submitted with this application and hereby made a part of this application. The Technical Appendix, and all references cited therein, are hereby incorporated by reference as if fully set forth herein.

At least the following documents are part of the technical appendix:
Scott Davis, “Coherent Axial Emission of Spontaneous Asynchronous Radiation” (unpublished).

1. A composition of matter, including a plurality of particles in tri-energy equilibrium; and
meeting a known translational selection requirement.

2. A method, including steps of
inducing translational energy to a plurality of particles;
allowing those particles to reach tri-energy equilibrium; and
selecting from that plurality only those particles meeting a known translational requirement.

3. Apparatus including
a thermal energizer;
an equilibrium region coupled to the thermal energizer;
a heteroscopic turbine coupled to the equilibrium region; and
a lasing region coupled to an output of the heteroscopic turbine.
